(19) United States
(12) Patent Application Publication
(10) Pub. No.: US 2007/0205882 A1
(43) Pub. Date: Sep. 6, 2007

(54) AIR TANK PRESSURE MONITORING

(75) Inventors: Rodney P. Ehrlich, Monticello, IN (US); Paul D. Nelson, Martinsville, IN (US); Victor Vargas, Lafayette, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: WABASH NATIONAL, L.P., Lafayette, IN (US)

(21) Appl. No.: 11/668,026

(22) Filed: Jan. 29, 2007

Related U.S. Application Data
(60) Provisional application No. 60/778,064, filed on Mar. 1, 2006.

(51) Int. Cl. B60C 23/00; G08B 21/00; B60Q 1/00

(52) U.S. Cl. 340/447; 340/438; 340/431

(57) ABSTRACT

An air tank monitoring system and method. An air tank pressure sensor which includes a microcontroller and a transceiver, such that the pressure sensor can send as well as receive and process information. Also provided is a wireless air tank status monitoring system which includes a wireless pressure transducer. The transducer is connected to a microcontroller which is powered by a battery. The microcontroller is connected to a transceiver which sends and receiver information using an antenna. The pressure information is communicated to a data concentrator or coordinator which includes a transceiver which sends and receives information using an antenna and a processor which processes the data and effectively controls the system.

### RELATED APPLICATION (PRIORITY CLAIM)

This application claims the benefit of U.S. Provisional Application Ser. No. 60/778,064, filed Mar. 1, 2006, which is hereby incorporated herein by reference in its entirety.

### BACKGROUND

The present invention generally relates to air tank monitoring systems, and more specifically relates to a wireless air tank monitor (such as a pressure sensor) and monitoring system, which can be used, for example, in a mesh network for vehicles, such as tractor-trailers.

Every combination vehicle in the trucking industry has two air lines for the braking system, the service line and the emergency lines. These lines run between each vehicle (i.e., tractor to trailer, trailer to dolly, dolly to second trailer, etc.). The service line (also called the control line or signal line) carries air, which is controlled by the foot brake or the trailer hand brake. When the brakes are applied, the pressure in the service line changes, depending on how hard the driver presses the foot brake or hand valve. The service line is connected to relay valves, and these valves allow the trailer brakes to be applied more quickly than would otherwise be possible.

The emergency line (also called the supply line) effectively has two purposes supplying air to the trailer air tanks; and controlling the emergency brakes on combination vehicles. Loss of air pressure in the emergency line causes the trailer emergency brakes to activate. The pressure loss could be caused by, for example, a trailer breaking loose, thus tearing apart the emergency air hose. Alternatively, the pressure loss could be caused by a hose, metal tubing, or other part breaking, thereby letting the air out. When the emergency line loses pressure, it also causes the tractor protection valve to close (i.e., the air supply knob pops out). “Glad hands” are coupling devices which are common in the industry, and they are used to connect the service and emergency air lines from the truck or tractor to the trailer. The couplers include a rubber seal, which prevents air from escaping. Before a connection is made, the couplers and rubber seals should be cleaned, to ensure a good connection. When connecting the glad hands, the two seals are pressed together with the couplers at a 90 degree angle relative to each other. Then, a turn of the glad hand (which is attached to the hose) works to join and lock the couplers. When coupling, one must make sure to couple the proper glad hands together. To avoid the emergency line being mistaken for the service line and vice versa, emergency lines are often coded with the color red (i.e., red hose, red couplers, or other parts), while the service line is often coded with the color blue. Alternatively, metal tags are attached to the lines with the words “service” and “emergency” stamped on them.

If the two air lines do become crossed, supply air is sent to the service line instead of going to charge the trailer air tanks. As a result, air will not be available to release the trailer spring brakes (i.e., parking brakes). If the spring brakes do not release when the trailer air supply control is pushed, one should check the air line connections, because the lines are probably crossed.

Each trailer and converter dolly has one or more air tanks which are filled by the emergency (i.e., supply) line from the tractor. They provide the air pressure which is used to operate the trailer brakes. Air pressure is sent from the air tanks to the brakes by relay valves. While the pressure in the service line tells how much pressure the relay valves should send to the trailer brakes, the pressure in the service line is controlled by the brake pedal (and the trailer hand brake).

With the spring powered emergency brake it is important to maintain air tank pressure to prevent the spring brake from dragging as is the case where the pressure slowly decays. When this happens the operator is not aware of the situation and continues to operate the vehicle wasting fuel and wearing the brake linings unnecessarily. Also this condition can be quite dangerous as the dragging emergency brake generates heat that can cause a fire. Detection of the pressure in the tank can prevent this situation. The bottom line is that it is important to keep the air brakes of a combination vehicle in good working order, and when the brakes are not in good working order, it is important that that be known, in order to avoid operating the vehicle in a dangerous situation.

### SUMMARY

Briefly, an embodiment of the present invention provides an air tank monitor which is configured to mount at an air tank and sense, for example, the air pressure in the tank. Preferably, the air pressure sensor also includes a microcontroller and a transceiver, such that the pressure sensor can send as well as receive and process information.

Another embodiment of the present invention provides a wireless air tank monitoring system which includes a pressure transducer. The transducer is connected to a microcontroller which is powered by a battery. The microcontroller is connected to a transceiver which sends and receives information using an antenna. The air pressure information is communicated to a data concentrator which includes a transceiver which sends and receives information using an antenna and a processor which processes the data and effectively controls the system.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein:

FIG. 1 is a block diagram of an air tank monitoring system which is in accordance with an embodiment of the present invention;

FIG. 2 shows how the system associates a wireless sensor with the network;

FIG. 3 illustrates beacon communication;

FIG. 4 illustrates non-beacon communication;

FIG. 5 shows how the wireless sensor relays information through an alternate node to provide that less power is required to transmit the information, thereby conserving its battery;

FIG. 6 is a flow chart which shows how the wireless sensor goes into sleep mode to conserve its battery;

FIG. 7 illustrates the different layers of a vehicle network in which the sensor disclosed herein could be used;

FIG. 8 illustrates a mesh network architecture with which the sensor disclosed herein could be used; and

FIG. 9 illustrates an example of the mesh network architecture of FIG. 8, implemented on a tractor-trailer.

### DESCRIPTION

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

An embodiment of the present invention provides an improved system and method for monitoring the status of an air tank on a vehicle, such as the air pressure of an air tank of a tractor-trailer or other combination vehicle. Within the system is a wireless air pressure sensor which is mountable at the air tank. The sensor is configured such that it need not continually transmit information, thereby prolonging the life of its battery and the sensor itself.

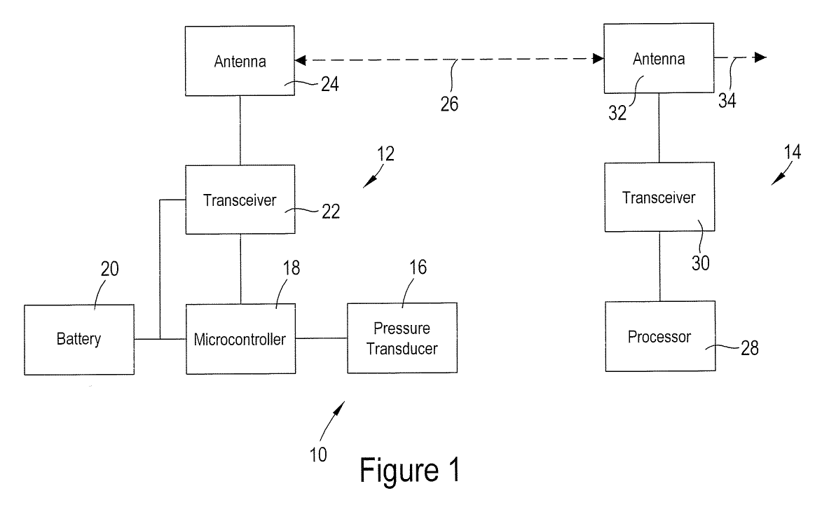

FIG. 1 illustrates an air tank status monitoring system 10 which is in accordance with an embodiment of the present invention. The system 10 includes a pressure sensor 12 and a data concentrator or coordinator 14. The sensor 12 includes a pressure transducer 16 which is connected to a microcontroller or interrogator 18. The microcontroller 18 is powered by a battery 20, and is connected to a transceiver 22 which transmits and receives data using an antenna 24. The microcontroller 18 could be a Freescale HCS08 microcontroller, and the pressure transducer 16 could be a Freescale MPXY 8040 pressure transducer. The sensor 12 sends information to, and receives information from, the data concentrator 14 (as indicated by line 26 in FIG. 1). The microcontroller 18 of the sensor(s) 12 may be configured to inform the data concentrator 14 whenever a pre-determined pressure has been reached.

The data concentrator 14 includes a processor 28 for processing data and controlling the overall system. The processor 28 is connected to a transceiver 30 which transmits and receives information using an antenna 32. Specifically, the transceiver 30 sends information to, and receives information from, the sensor 12 (as indicated by line 26 in FIG. 1) as well as possibly to and from another, remote site (as indicated by line 34 in FIG. 1). Specifically, the processor 28 may be configured to transmit raw or abstracted data to a management center that provides troubleshooting information, makes resource management decisions (such as preparing parts or labor resources to make a repair), and tracks problems in all or a subset of the commercial vehicles being managed. Preferably, for security reasons, all data that is communicated along lines 26 and 34 in FIG. 1 is encrypted.

Preferably, the processor 28 is configured such that the system 10 not only provides for monitoring, but also for the production of diagnostic and/or prognostic results. Preferably, the data concentrator 14 is configured to request that the sensed data be transmitted by the sensor(s) 12 at pre-determined time periods, said time periods being determined by the data concentrator 14. The microcontroller 18 of the sensor(s) 12 may be configured such that, under certain operational conditions, the sensor(s) 12 alert the data concentrator 14 that a condition exists that might require immediate attention.

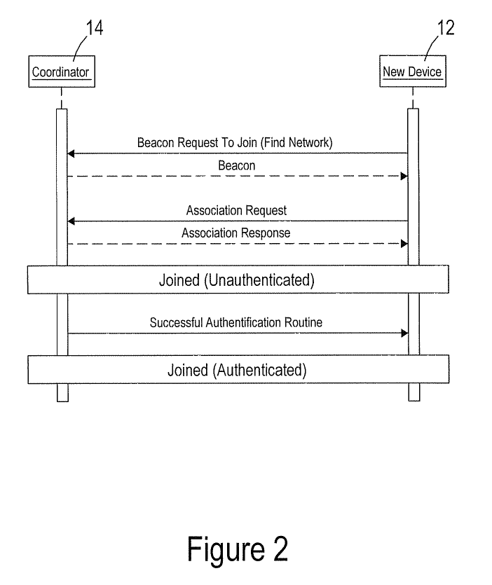

Preferably, the microcontroller 18 of the sensor 12 and the processor 28 of the data concentrator 14 are configured such that the wireless sensor 12 can automatically associate itself with the data concentrator 14, as shown in FIG. 2.

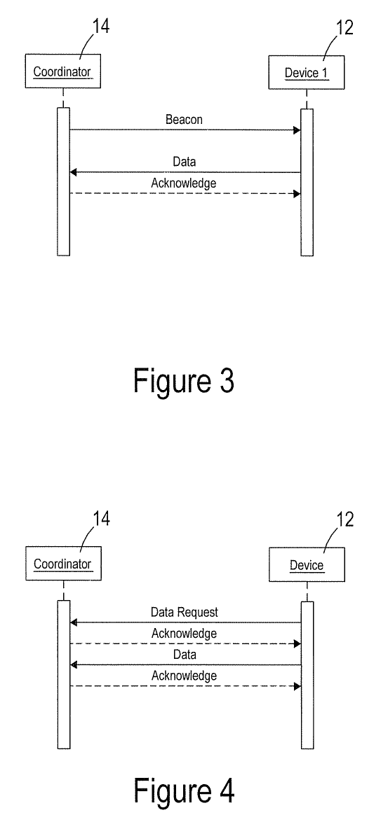

Communication of information from the sensor 12 to the data concentrator 14 shown in FIG. 1 can be performed either as a beacon-type communication or as a non-beacon type communication. Beacon mode is illustrated in FIG. 3 and offers maximum power savings because the data concentrator 14 need not be continuously waiting for communication from the sensor 12. In beacon mode, the sensor 12 effectively “watches out” for the data concentrator's 14 beacon that gets transmitted periodically, locks on and looks for messages addressed to it. If message transmission is complete, the data concentrator 14 dictates a schedule for the next beacon so that the sensor 12 effectively “goes to sleep” with regard to information transmission. The data concentrator 14 may also switch to sleep mode.

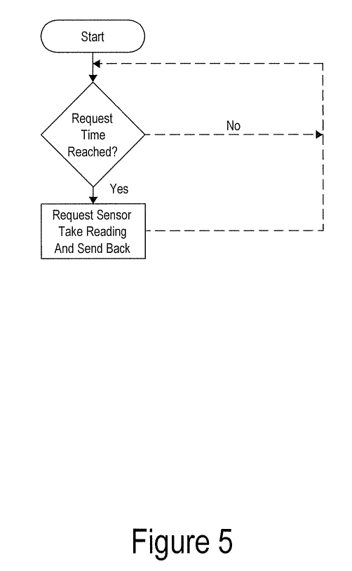

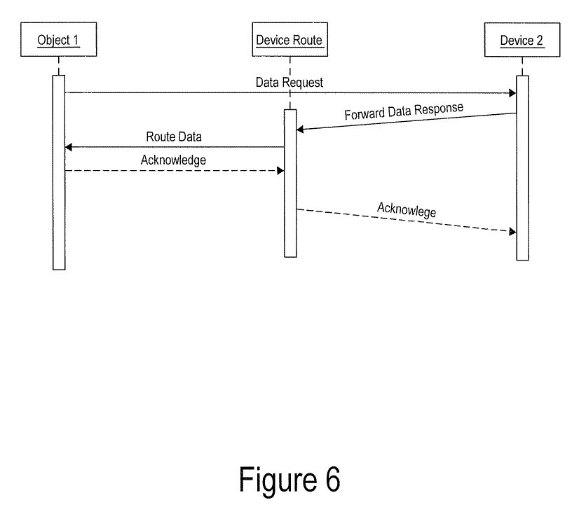

In non-beacon mode, as shown in FIG. 4, the sensor 12 wakes up and confirms its continued presence in the network at random intervals. On detection of activity, the sensor 12 ‘springs to attention’, as it were, and transmits to the ever-waiting data concentrator's transceiver 30. If the sensor 12 finds the channel busy, the acknowledgement allows for retry until success. As shown in FIG. 5, the sensor(s) 12 can be configured to send information periodically to the data concentrator 14. Additionally, as shown in FIG. 6, the sensor(s) 12 can be configured to relay information through an alternate node that will allow lower transmit power and conserve battery drain.

Other functionality which could be provided may include, but may not be limited to: the sensor 12 and/or data concentrator 14 being able to determine the leak rate of the air tank, and/or determine the condition of the battery 20 of the sensor 12. The microcontroller 18 can be configured such that it effectively maintains a gage in memory in order to keep track of how much the sensor 12 has used its battery so the sensor 12 could alert the data concentrator 14 when the battery power reaches a predetermined level.

Additionally the microcontroller 18 can be configured to send an alert message to the data concentrator 14, indicating dangerous situations that could be developing with regard to air tank pressure. Upon recognizing a dangerous condition, the processor 28 of the data concentrator 14 can send a message to the driver of the vehicle, such as via an indication on the dashboard. The information can be made available to both the driver of the vehicle as well as via an external communication device to the management network. Preferably, the sensor 12 periodically “wakes up” and takes pressure measurements, and these measurements are stored (i.e., minimum pressure, maximum pressure, etc. ), and at the request of the interrogator, all of this information is sent to the interrogator, thereby greatly increasing the battery life of the sensor. Preferably, the interrogator forwards information to the management network based on particular air tank state (i.e., low tank pressure for a period of time or mileage after driver alert). This can be implemented in such a way that, if a driver is driving in an abusive manner, this can be time stamped and sent to the home office so that it might be used at a reprimand.

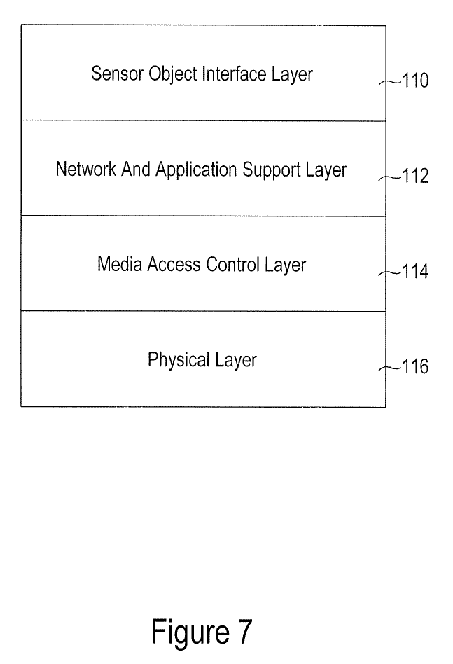

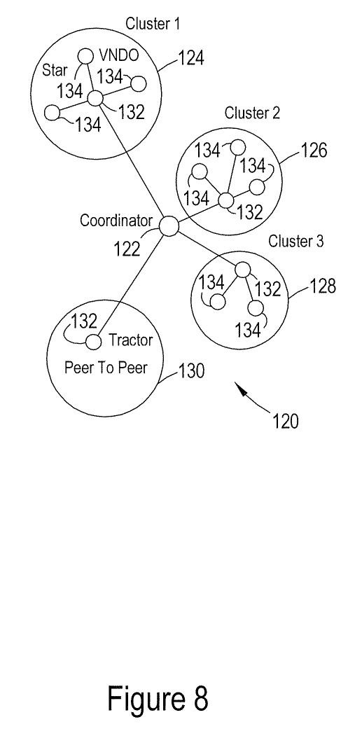

FIG. 7 illustrates the different layers of a wireless mesh network with which the system 10 shown in FIG. 1 can be used. As shown in FIG. 7, the layers include a Sensor Object Interface Layer 110, a Network and Application Support Layer (NWK) 112, a Media Access Control (MAC) Layer 114, and a Physical Layer 116. The NWK layer 112 is configured to permit growth of the network without having to use high power transmitters, and is configured to handle a huge number of nodes. The NWK layer 112 provides the routing and multi-hop capability required to turn MAC level 114 communications into a mesh network. For end devices, this amounts to little more than joining and leaving the network. Routers also have to be able to forward messages, discover neighboring devices and build up a map of the routes to other nodes. In the coordinator (identified with reference numeral 122 in FIG. 8), the NWK layer 112 can start a new network and assign network addresses to new devices when they join the network for the first time. This level in the vehicle network architecture includes the Vehicle Network Device Object (VNDO) (identified in FIG. 8), user-defined application profile(s) and the Application Support (APS) sub-layer, wherein the APS sub-layer's responsibilities include maintenance of tables that enable matching between two devices and communication among them, and also discovery, the aspect that identifies other devices that operate in the operating space of any device.

The responsibility of determining the nature of the device (Coordinator or Full Function Sensor) in the network, commencing and replying to binding requests and ensuring a secure relationship between devices rests with the VNDO. The VNDO is responsible for overall device management, and security keys and policies. One may make calls to the VNDO in order to discover other devices on the network and the services they offer, to manage binding and to specify security and network settings. The user-defined application refers to the end device that conforms architecture (i.e., an application is the software at an end point which achieves what the device is designed to do).

The Physical Layer 116 shown in FIG. 7 is configured to accommodate high levels of integration by using direct sequences to permit simplicity in the analog circuitry and enable cheaper implementations. The physical Layer 116 may be off the shelf hardware such as the Maxstream XBEE module, with appropriate software being used to control the hardware and perform all the tasks of the network as described below.

The Media Access Control (MAC) Layer 114 is configured to permit the use of several topologies without introducing complexity and is meant to work with a large number of devices. The MAC layer 114 provides reliable communications between a node and its immediate neighbors. One of its main tasks, particularly on a shared channel, is to listen for when the channel is clear before transmitting. This is known as Carrier Sense Multiple Access-Collision Avoidance communication, or CSMA-CA. In addition, the MAC layer 114 can be configured to provide beacons and synchronization to improve communications efficiency. The MAC layer 114 also manages packing data into frames prior to transmission, and then unpacking received packets and checking them for errors.

There are three different vehicle network device types that operate on these layers, each of which has an addresses (preferably there is provided an option to enable shorter addresses in order to reduce packet size), and is configured to work in either of two addressing modes—star or peer-to-peer.

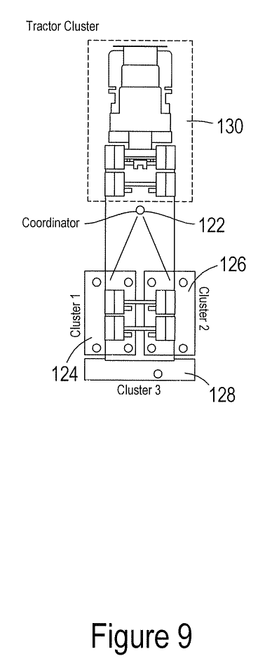

FIG. 7 designates the layers associated with the network, meaning the physical (hardware) and interfaced to the MAC that controls the actual performance of the network. FIG. 7 is a description of one “node” while FIG. 9 shows the topology of individual “nodes” and how they are tied together to form the network.

FIG. 8 illustrates a mesh network architecture with which the system shown in FIG. 1 can be used. As shown, the network 120 includes a coordinator 122, and a plurality of clusters 124, 126, 128, 130. Each cluster includes several devices 132, 134 such as sensors, each of which is assigned a unique address. One of the devices (identified with reference numeral 132) of each cluster is configured to receive information from the other devices in the cluster (identified with reference numeral 134), and transmit information to the coordinator 122. The coordinator 122 not only receives information about the network, but is configured to route the information to other networks (as represented by arrow 36 in FIG. 8). As will be described in more detail hereinbelow, the network 120 could be disposed on a tractor-trailer, wherein the devices 132, 134 comprise different sensors, such as pressure sensors, temperature sensors, voltage sensors and switch controls, all of which are located in areas relatively close to each other.

The mesh network architecture provides that the sensors, and the overall network, can effectively self-organize, without the need for human administration. Specifically, the Vehicle Network Device Object (VNDO) (identified in FIG. 8) is originally not associated with any network. At this time it will look for a network with which to join or associate. The coordinator 122 “hears” the request coming from the non-associated VNDO and if it is pertinent to its network will go through the process of binding the VNDO to the network group. Once this association happens, the VNDO learns about all the other VNDO's in the associated network so it can directly talk to them and route information through them. In the same process, the VNDO can disassociate itself from the network as in the case of a tractor (VNDO) leaving the trailer (Coordinator) and then associating itself to a new trailer. The VNDO is an embodiment of both hardware and software to affect the performance of the network. This includes how each element interacts with each other, messages passed, security within the network, etc.

As shown in FIG. 8, there is one, and only one, coordinator (identified with reference numeral 122) in each network to act as the router to other networks, and can be likened to the root of a (network) tree. It is configured to store information about the network. Each cluster includes a full function sensor (FFS) (identified with reference numeral 132) which is configured to function as an intermediary router, transmitting data to the coordinator 122 which it receives from other devices (identified with reference numeral 134). Preferably, each FFS is configured to operate in all topologies and is configured to effectively act as a coordinator for that particular cluster.

The architecture shown in FIG. 8 is configured to provide low power consumption, with battery life ranging from a month to many years. In the vehicle network, longer battery life is achievable by only being used when a requested operation takes place. The architecture also provides high throughput and low latency for low duty-cycle applications, channel access using Carrier Sense Multiple Access with Collision Avoidance (CSMA-CA), addressing space for over 65000 address devices, a typical range of 1100 m, a fully reliable “hand-shaked” data transfer protocol, and different topologies as illustrated in FIG. 8, i.e., star, peer-to-peer, mesh.

The mesh network architecture shown in FIG. 8 has the ability to be able to enhance power saving, thus extending the life of the module based on battery capacity. The architecture is configured to route the information through nodes 132, 134 in the network and also has the ability to reduce the power needed to transmit information. Specifically, natural battery life extension exists as a result of passing information through nodes that are in close proximity to each other.

The sensors 132, 134 in the network are configured such that they are able to go into sleep mode—a mode of operation that draws an extremely low amount of battery current. Each sensor 132, 134 may be configured such that it periodically wakes, performs its intended task and if the situation is normal, returns to its sleep mode. This manner of operation greatly extends the life of the unit by not continually transmitting information, which in a typical vehicle network is the greatest drain on the battery capacity. While in sleep mode, the gateway device 132 requests information from the other devices 134 in the cluster. Acting on this request, the devices 134 wake up, perform the intended task, send the requested information to the gateway device 132, and return to sleep mode.

The vehicle network may be configured to addresses three different data traffic protocols:

1. Data is periodic. The application dictates the rate, and the sensor activates, checks for data and deactivates. The periodic sampling data model is characterized by the acquisition of sensor data from a number of remote sensor nodes and the forwarding of this data to the gateway on a periodic basis. The sampling period depends mainly on how fast the condition or process varies and what intrinsic characteristics need to be captured. This data model is appropriate for applications where certain conditions or processes need to be monitored constantly. There are a couple of important design considerations associated with the periodic sampling data model. Sometimes the dynamics of the monitored condition or process can slow down or speed up; if the sensor node can adapt its sampling rates to the changing dynamics of the condition or process, over-sampling can be minimized and power efficiency of the overall network system can be further improved. Another critical design issue is the phase relation among multiple sensor nodes. If two sensor nodes operate with identical or similar sampling rates, collisions between packets from the two nodes are likely to happen repeatedly. It is essential for sensor nodes to be able to detect this repeated collision and introduce a phase shift between the two transmission sequences in order to avoid further collisions.

2. Data is intermittent (event driven). The application, or other stimulus, determines the rate, as in the case of door sensors. The device needs to connect to the network only when communication is necessitated. This type of data communication enables optimum saving on energy. The event-driven data model sends the sensor data to the gateway based on the happening of a specific event or condition. To support event-driven operations with adequate power efficiency and speed of response, the sensor node must be designed such that its power consumption is minimal in the absence of any triggering event, and the wake-up time is relatively short when the specific event or condition occurs. Many applications require a combination of event-driven data collection and periodic sampling.

3. Data is repetitive (store and forward), and the rate is fixed a priori. Depending on allotted time slots, devices operate for fixed durations. With the store-and-forward data model, the sensor node collects data samples and stores that information locally on the node until the transmission of all captured data is initiated. One example of a store-and-forward application is where the temperature in a freight container is periodically captured and stored; when the shipment is received, the temperature readings from the trip are downloaded and viewed to ensure that the temperature and humidity stayed within the desired range. Instead of immediately transmitting every data unit as it is acquired, aggregating and processing data by remote sensor nodes can potentially improve overall network performance in both power consumption and bandwidth efficiency.

Two different bi-directional data communication models which may be utilized in connection with the present invention are polling and on-demand.

With the polling data model, a request for data is sent from the coordinator via the gateway to the sensor nodes which, in turn, send the data back to the coordinator. Polling requires an initial device discovery process that associates a device address with each physical device in the network. The controller (i.e., coordinator) then polls each wireless device on the network successively, typically by sending a serial query message and retrying as needed to ensure a valid response. Upon receiving the query's answer, the controller performs its pre-programmed command/control actions based on the response data and then polls the next wireless device.

The on-demand data model supports highly mobile nodes in the network where a gateway device is directed to enter a particular network, binds to that network and gathers data, then un-binds from that network. An example of an application using the on-demand data model is a tractor that connects to a trailer and binds the network between that tractor and trailer, which is accomplished by means of a gateway. When the tractor and trailer connect, association takes place and information is exchanged of information both of a data plate and vital sensor data. Now the tractor disconnects the trailer and connects to another trailer which then binds the network between the tractor and new trailer. With this model, one mobile gateway can bind to and un-bind from multiple networks, and multiple mobile gateways can bind to a given network. The on-demand data model is also used when binding takes place from a remote situation such as if a remote terminal was to bind with a trailer to evaluate the state of health of that trailer or if remote access via cellular or satellite interface initiates such a request.

Referring to FIG. 8, the functions of the coordinator 122, which usually remains in the receptive mode, encompass network set-up, beacon transmission, node management, storage of node information and message routing between nodes. The network nodes, however, are meant to save energy (and so ‘sleep’ for long periods) and their functions include searching for network availability, data transfer, checking for pending data and querying for data from the coordinator.

Comparing FIG. 1 to FIG. 8, the data concentrator 14 of FIG. 1 can be used as the coordinator 122 of FIG. 8, and the sensor 12 of FIG. 1 (and hence also the sensor assembly 12a of FIG. 2) can be used for at least some of the devices 132, 134 of FIG. 8.

FIG. 9 illustrates an arrangement which is possible on a tractor-trailer. For the sake of simplicity without jeopardizing robustness, this particular architecture defines a quartet frame structure and a super-frame structure used optionally only by the coordinator. The four frame structures are: a beacon frame for the transmission of beacons; a data frame for all data transfers; an acknowledgement frame for successful frame receipt confirmations; and a MAC command frame.

These frame structures and the coordinator's super-frame structure play critical roles in security of data and integrity in transmission. The coordinator lays down the format for the super-frame for sending beacons. The interval is determined a priori and the coordinator thus enables time slots of identical width between beacons so that channel access is contention-less. Within each time slot, access is contention-based. Nonetheless, the coordinator provides as many guaranteed time slots as needed for every beacon interval to ensure better quality.

With the vehicle network designed to enable two-way communications, not only will the driver be able to monitor and keep track of the status of his vehicle, but also feed it to a computer system for data analysis, prognostics, and other management features for the fleets.

While embodiments of the invention are shown and described, it is envisioned that those skilled in the art may devise various modifications without departing from the spirit and scope of the foregoing description.

What is claimed is:

1. An air tank pressure monitor comprising: a pressure transducer; a transceiver; a microcontroller connected to the transceiver, said pressure transducer being connected to the microcontroller, wherein the microcontroller is configured to receive pressure-related information from the pressure transducer and use the transceiver to wirelessly transmit air tank pressure information.

2. An air tank pressure monitor as recited in claim 1, further comprising an antenna which is connected to the transceiver, wherein the air tank pressure monitor is configured such that the transceiver uses the antenna to transmit air tank pressure information.

3. An air tank pressure monitor as recited in claim 1, further comprising a battery which powers the microcontroller.

4. An air tank pressure monitor as recited in claim 1, wherein the air tank pressure monitor is configured to not only wirelessly transmit air tank pressure information, but is also configured to wirelessly receive information.

5. An air tank pressure monitor as recited in claim 4, wherein the air tank pressure monitor is configured to wirelessly receive and implement instructions regarding when to wirelessly transmit air tank pressure information.

6. An air tank pressure monitor as recited in claim 1, wherein the air tank pressure monitor is configured to wirelessly communicate in a beacon-type communication, wherein the air tank pressure monitor is configured to watch out for a beacon.

7. An air tank pressure monitor as recited in claim 1, wherein the air tank pressure monitor is configured to wirelessly communicate in a non-beacon-type communication, wherein the air tank pressure monitor is configured to periodically wake up and take at least one pressure measurement.

8. An air tank pressure monitor as recited in claim 1, wherein the air tank pressure monitor is configured to associate with a wireless mesh network.

9. An air tank pressure monitor as recited in claim 1, wherein the air tank pressure monitor is configured such that the air tank pressure monitor can be put into a sleep mode when directed by a data concentrator.

10. An air tank pressure monitor as recited in claim 9, wherein the air tank pressure monitor is configured such that the air tank pressure monitor can be woken up and made active when directed by the data concentrator.

11. An air tank pressure monitoring system comprising:
an air tank pressure monitor comprising a pressure transducer; a transceiver; a microcontroller connected to the transceiver, said pressure transducer being connected to the microcontroller, wherein the microcontroller is configured to receive pressure-related information from the pressure transducer and use the transceiver to wirelessly transmit air tank pressure information; and
a data concentrator comprising a transceiver; a processor connected to the transceiver, wherein the data concentrator is configured to wirelessly receive pressure-related information from the an air tank pressure monitor.

12. An air tank pressure monitoring system as recited in claim 11, wherein the air tank pressure monitor further comprises an antenna which is connected to the transceiver of the air tank pressure monitor, wherein the air tank pressure monitor is configured such that the transceiver of the air tank pressure monitor uses the antenna of the air tank pressure monitor to transmit air tank pressure information to the data concentrator.

13. An air tank pressure monitoring system as recited in claim 11, wherein the air tank pressure monitor further comprises a battery which powers the microcontroller of the air tank pressure monitor.

14. An air tank pressure monitoring system as recited in claim 11, wherein the air tank pressure monitor is configured to not only wirelessly transmit air tank pressure information to the data concentrator, but is also configured to wirelessly receive information from the data concentrator.

15. An air tank pressure monitoring system as recited in claim 14, wherein the air tank pressure monitor is configured to wirelessly receive and implement instructions from the data concentrator regarding when to wirelessly transmit air tank pressure information to the data concentrator.

16. An air tank pressure monitoring system as recited in claim 11, wherein the air tank pressure monitor is configured to wirelessly communicate with the data concentrator in a beacon-type communication, wherein the air tank pressure monitor is configured to watch out for a beacon from the data concentrator.

17. An air tank pressure monitoring system as recited in claim 11, wherein the air tank pressure monitor is configured to wirelessly communicate with the data concentrator in a non-beacon-type communication, wherein the air tank pressure monitor is configured to periodically wake up and take at least one pressure measurement.

18. An air tank pressure monitoring system as recited in claim 11, wherein the air tank pressure monitor is configured to associate with a wireless mesh network.

19. An air tank pressure monitoring system as recited in claim 11, wherein the microcontroller of the air tank pressure monitor and the processor of the data concentrator are configured such that the air tank pressure monitor can automatically associate itself with the data concentrator.

20. An air tank pressure monitor as recited in claim 11, wherein the air tank pressure monitor is configured such that the air tank pressure monitor can be put into a sleep mode when directed by the data concentrator.

21. An air tank pressure monitor as recited in claim 20, wherein the air tank pressure monitor is configured such that the air tank pressure monitor can be woken up and made active when directed by the data concentrator.
